(19) United States
(12) Patent Application Publication
(10) Pub. No.: US 2009/0279306 A1
(43) Pub. Date: Nov. 12, 2009

(54) Lighting Apparatus

(75) Inventors: Ying-Fu Wang, Kaohsiung (TW); Yen-Chuan Chu, Kaohsiung (TW); Yi-Jen Chiu, Kaohsiung (TW); Chung-Yung Tai, Kaohsiung (TW); Thung-Chi Wu, Kaohsiung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: RADIANT OPTO-ELECTRONICS CORPORATION, Kaohsiung (TW)

(21) Appl. No.: 12/169,274

(22) Filed: Jul. 8, 2008

(30) Foreign Application Priority Data
May 12, 2008 (TW) 97117462

(51) Int. Cl. F21V 7/00

(52) U.S. Cl. 362/307

(57) ABSTRACT

A lighting apparatus is disclosed. The lighting apparatus comprises a casing, at least one light source and a microstructure cover. The light source is disposed on one side of the casing. The microstructure cover is mounted on the casing opposite to the reflective face thereof. The microstructure cover has a plurality of guiding micro-structures to guide light and a plurality of dispersing micro-structures to disperse light.

### RELATED APPLICATIONS

This application claims priority to Taiwan Application Serial Number 97117462, filed May 12, 2008, which is herein incorporated by reference.

### FIELD OF THE INVENTION

This invention relates to a lighting apparatus, and more particularly, to a lighting apparatus for indirect lighting.

### BACKGROUND OF THE INVENTION

Currently, lighting apparatus or lamps are widely used in the daily life. Consider lighting apparatus that use light emitting diodes (LEDs) for example, the LEDs have several beneficial characteristics, including low electrical power consumption, low heat generation, long operational life, small volume, good impact resistance, fast response and excellent stability. Therefore, the LED is one kind of the suitable light source of the lighting apparatus.

When the lighting apparatus has a light source with high brightness (such as LED) for lighting the environment, the lighting apparatus can have higher lighting efficiency. However, the lighting apparatus with high brightness may have problems of such as uneven lighting and the glare.

Further, conventional lighting apparatus may use a light guide to guide the light emitted from the light source and form the indirect lighting for uniform light. However, the light guide increases the weight and the cost of the lighting apparatus.

### SUMMARY OF THE INVENTION

Therefore, an aspect of the present invention is to provide a lighting apparatus to perform indirect lighting, and further to guide and uniform the light emitted there form.

Another aspect of the present invention is to provide a lighting apparatus to reduce the number of components thereof, thereby reducing the weight and the component cost thereof.

Another aspect of the present invention is to provide a lighting apparatus with the light source to emit light laterally, thereby reducing the number of light sources.

According to an embodiment of the present invention, the lighting apparatus comprises a casing, at least one light source and a microstructure cover. The casing includes a chamber and a reflective surface, wherein the reflective surface is formed in the chamber. The light source is disposed on at least one side of the chamber. The microstructure cover is mounted on the chamber of the casing and opposite to the reflective surface, wherein the microstructure cover comprises a substrate, a plurality of guiding micro-structures and a plurality of dispersing micro-structures. The guiding micro-structures are formed on at least one or two opposite sides of the substrate, wherein the guiding micro-structures guides the light emitted from the light source in a direction which is substantially vertical to the substrate. The dispersing micro-structures are formed on at least one of two opposite sides of the substrate, wherein the dispersing micro-structures disperses the light emitted from the light source.

Therefore, with the use of the lighting apparatus disclosed in the embodiments of the present invention, the problems of uneven lighting and glare can be reduced, and the components thereof are simple, thereby reducing the weight and the component cost thereof.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A, FIG. 1B and FIG. 1C are cross-section views showing a lighting apparatus according to a first embodiment of the present invention;

FIG. 2A and FIG. 2B are cross-section views showing a lighting apparatus according to a second embodiment of the present invention;

FIG. 3A and FIG. 3B are cross-section views showing a lighting apparatus according to a third embodiment of the present invention; and

FIG. 4 is a cross-section view showing a microstructure cover according to a fourth embodiment of the present invention.

### DETAILED DESCRIPTION OF THE PREFERRED EMBODIMENT

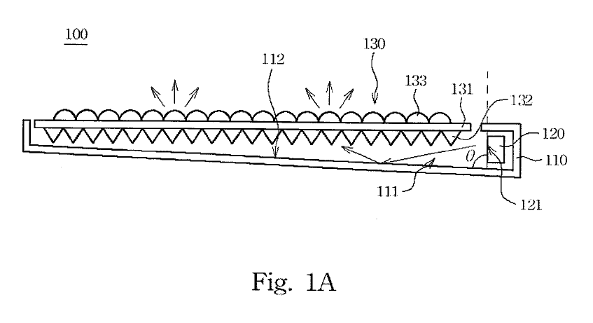

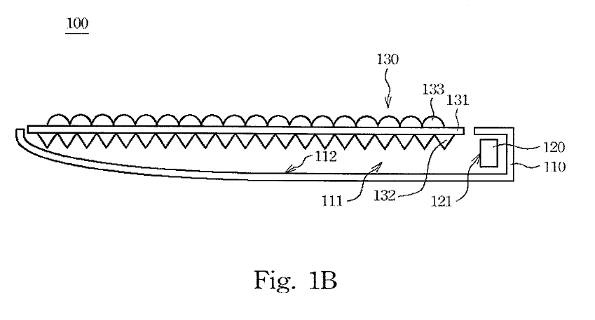

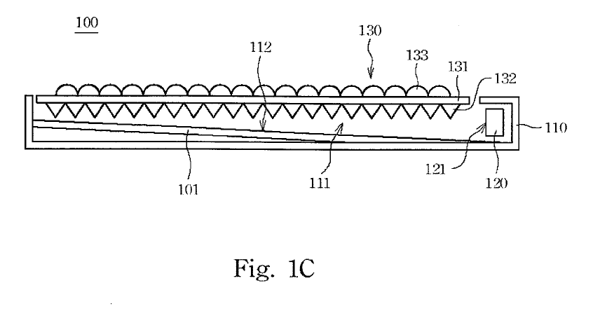

In order to make the illustration of the present invention more explicit and complete, the following description is stated with reference to FIG. 1A through FIG. 4.

Refer to FIG. 1A, FIG. 1B and FIG. 1C. FIG. 1A, FIG. 1B and FIG. 1C are cross-section views showing a lighting apparatus according to a first embodiment of the present invention. The lighting apparatus (or a lamp) 100 of the present embodiment can be used to light the environment. The lighting apparatus 100 may comprise a casing 110, at least one light source 120 and a microstructure cover 130. The light source 120 is disposed in the casing to laterally emit light. The microstructure cover is disposed to cover an opening of the casing and guide the light emitted from the light source 120 towards a predetermined direction, thereby providing a uniform, indirect light source with minimal glare.

Refer to FIG. 1A, FIG. 1B and FIG. 1C again. The casing 110 (or a lampshade) may be in the form of a flat plate shape and made of opaque material, such as plastic material, metal or any composition thereof. The casing 110 includes a chamber 111 and a reflective surface 112. The chamber 111 can receive the light source 120, wherein a light reflective material (such as Au, Ag, Al, Cr, Cu, In, Ir, Ni, Pt, Re, Rh, Sn, Ta, W, Mn, white paint with etiolation-resistant and heat-resistant or any composition thereof) is formed on the inner sidewall thereof to reflect light that is not emitted straight to the reflective surface 112 or the microstructure cover 130. The reflective surface 112 may be a plane surface or a curved surface formed in the chamber 111 facing the light source 120 to reflect the light emitted form the light source 120 towards the microstructure cover 130. The reflective surface 112 may include the above-mentioned light reflective material to improve the reflective efficiency. In the present embodiment, the reflective surface 112 may be formed as one piece together with the casing 110 and on the bottom side of the chamber 111. However, in an embodiment, the casing 110 may further include a reflective film 101 in the chamber 111 to form the reflective surface 112 (referring to FIG. 1C) but not limited to the above description.

Refer to FIG. 1A, FIG. 1B and FIG. 1C again. The at least one light source 120 of the present embodiment may be selected from a group consisting of a cold cathode fluorescent lamp (CCFL), a hot cathode fluorescent lamp (HCFL), a light emitting diode (LED), a halogen lamp, a high intensity discharge (HID) lamp and an incandescent Lamp. The light source 120 is disposed on one side of the chamber 111 of the casing 110 and may include a light emitting surface 121 to emit the light. The angle θ between the reflective surface 112 of the casing 110 and the light emitting surface 121 of the light source 120 is preferably less than 90 degrees, i.e. the light emitted from the light source 120 is preferably not parallel to the reflective surface 112, thereby allowing the light to be emitted directly to the reflective surface 112 and to be reflected towards the microstructure cover 130.

Refer to FIG. 1A, FIG. 1B and FIG. 1C again. The microstructure cover 130 of the present embodiment may use any assembling method or mounting method to be mounted on the opening of the casing 110 and cover the chamber 111 thereof. The microstructure cover 130 may be made as one piece using a method such as casting, die-casting, machining or injection molding. The material of the microstructure cover 130 may be transparent or translucent material, such as photo-curing resin, propylene, polymethylmethacrylate (PMMA) or Polycarbonate (PC). The microstructure cover 130 includes a substrate 131, a plurality of guiding micro-structures 132 and a plurality of dispersing micro-structures 133. The guiding micro-structures 132 and the dispersing micro-structures 133 are preferably formed as one piece together with the substrate 131 and on at least one side thereof. The thickness of the substrate 131 is preferably larger than 1 mm to provide sufficient structural strength for the microstructure cover 130 held on the casing 110, thereby preventing the microstructure cover 130 form deflection and being unable to be mounted on the casing 110 securely. In the present embodiment, the guiding micro-structures 132 are formed on one side of the substrate 131 and face to the reflective surface 112 of the casing 110 to guide the light in a direction which is substantially vertical to the substrate 131, and the dispersing micro-structures 133 are formed on the opposite side thereof to disperse the light. However, in one embodiment, the dispersing micro-structures 133 are formed on one side of the substrate 131 and face the reflective surface 112 of the casing 110, and the guiding micro-structures 132 are formed on the opposite side thereof but not limited to the above description. The guiding micro-structures 132 may be triangular awl structures, triangular pillar structures, Fresnel lens structures or any combination thereof. The dispersing micro-structures 133 may be semicircle pillar structures, semicircle protruding structures, fish-eye lens structures or any combination thereof.

When the lighting apparatus 100 of the present embodiment is used for lighting, the light is emitted laterally form the light source 120 to the reflective surface 112 of the casing 110, and is reflected to the microstructure cover 130 to output. At this time, the guiding micro-structures 132 of the microstructure cover 130 can guide the light to output, and the dispersing micro-structures 133 can disperse the light for uniformity, thereby reducing the problems of such as uneven lighting and the glare.

Therefore, the lighting apparatus 100 of the present embodiment can provide uniform and comfortable light, and the components thereof are simple, thereby reducing the weight and the component cost thereof.

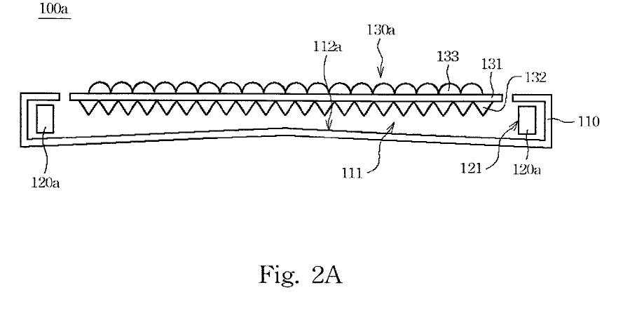

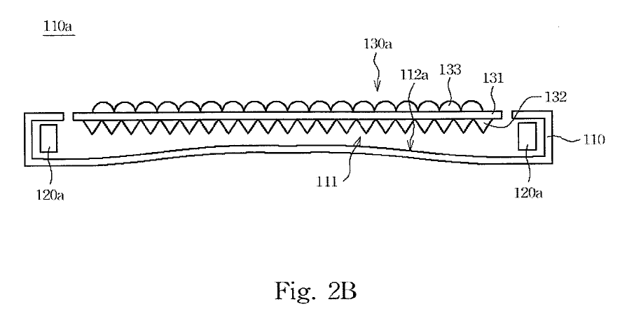

Refer to FIG. 2A and FIG. 2B. FIG. 2A and FIG. 2B are cross-section views showing a lighting apparatus according to a second embodiment of the present invention. Some reference numerals shown in the first embodiment are used in the second embodiment of the present invention. The construction shown in the second embodiment is similar to that in the first embodiment with respect to configuration and function, and thus is not stated in detail herein.

Referring again to FIG. 2A and FIG. 2B, in comparison with the first embodiment, the lighting apparatus 100a of the second embodiment may include two light sources 120a or two sets of light sources 120a respectively disposed at two opposite sides of the chamber 111 of the casing 110a to emit light towards the reflective surface 112a. At this time, the portion (such as the middle portion) of the reflective surface 112a may protrude towards the microstructure cover 130. Therefore, the angle θ between the reflective surface 112a of the casing 110a and the light emitting surface 121 of the light source 120a is less than 90 degrees, thereby allowing the light to emitted straight to the reflective surface 112 and reducing the loss of the light.

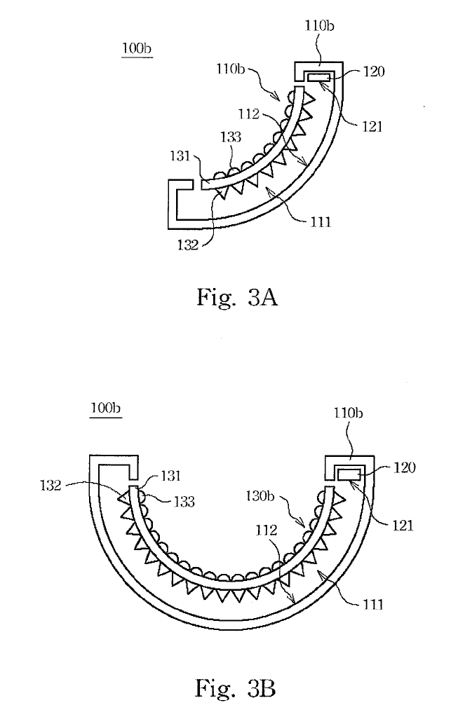

Refer to FIG. 3A and FIG. 3B. FIG. 3A and FIG. 3B are cross-section views showing a lighting apparatus according to a third embodiment of the present invention. Some reference numerals shown in the first embodiment are used in the third embodiment of the present invention. The construction shown in the third embodiment is similar to that in the first embodiment with respect to configuration and function, and thus is not stated in detail herein.

Referring again to FIG. 3A and FIG. 3B, in comparison with the first embodiment, the profile of the lighting apparatus 100b of the third embodiment may be in the form of a curved shape, such as L-shaped structure or U-shaped structure. At this time, the profile of the casing 110b may be L-shaped or U-shaped or in the form of other shapes, and the microstructure cover 130b preferably corresponds to the casing 110b to be L-shaped or U-shaped. Alternatively, the microstructure cover 130b may be in the form of a flat plate shape and mounted on the casing 110b. Therefore, the lighting apparatus 100b of the present embodiment can have various designs and shapes.

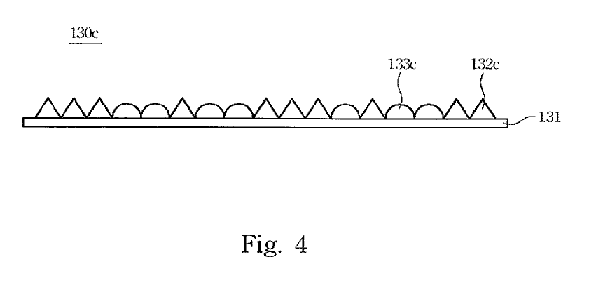

Refer to FIG. 4. FIG. 4 is a cross-section view showing a microstructure cover according to a fourth embodiment of the present invention. Some reference numerals shown in the first embodiment are used in the fourth embodiment of the present invention. The construction shown in the fourth embodiment is similar to that in the first embodiment with respect to configuration and function, and thus is not stated in detail herein.

Referring again to FIG. 4, in comparison with the first embodiment, the guiding micro-structures 132c and the dispersing micro-structures 133c of the microstructure cover 130c may be formed on one side of the substrate 131 faced to or opposite to the reflective surface 112. At this time, the guiding micro-structures 132c and the dispersing micro-structures 133c are preferably formed on the substrate 131 randomly to further uniform the light.

Therefore, the lighting apparatus of the invention can use the high brightness light source (such as LED) to provide uniform and comfortable light and reduce uneven lighting and glare. Further, the components of the lighting apparatus are simple, thereby reducing the weight and the component cost thereof. Moreover, since the light source of the lighting apparatus emits light laterally to form the indirect lighting, the number of the light sources used therein can be reduced.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A lighting apparatus, comprising:
a casing including a chamber and a reflective surface, wherein the reflective surface is formed in the chamber;
at least one light source disposed on at least one side of the chamber; and
a microstructure cover mounted on the chamber of the casing and opposite to the reflective surface, wherein the microstructure cover comprises:
a substrate;
a plurality of guiding micro-structures formed on at least one or two opposite sides of the substrate, wherein the guiding micro-structures guides the light emitted from the light source in a direction which is substantially vertical to the substrate; and
a plurality of dispersing micro-structures formed on at least one of two opposite sides of the substrate, wherein the dispersing micro-structures disperses the light emitted from the light source.

2. The lighting apparatus as claimed in claim 1, wherein the casing is in the form of a flat plate shape.

3. The lighting apparatus as claimed in claim 1, wherein the casing includes a light reflective material formed on the inner sidewall thereof, the light reflective material is selected from a group consisting of Au, Ag, Al, Cr, Cu, In, Ir, Ni, Pt, Re, Rh, Sn, Ta, W, Mn and white paint with etiolation-resistant and heat-resistant.

4. The lighting apparatus as claimed in claim 1, wherein the reflective surface is a plane surface.

5. The lighting apparatus as claimed in claim 1, wherein the reflective surface is a curved surface.

6. The lighting apparatus as claimed in claim 1, wherein the reflective surface includes a light reflective material formed thereon, the light reflective material is selected from a group consisting of Au, Ag, Al, Cr, Cu, In, Ir, Ni, Pt, Re, Rh, Sn, Ta, W, Mn and white paint with etiolation-resistant and heat-resistant.

7. The lighting apparatus as claimed in claim 1, wherein the casing further includes a reflective film in the chamber to form the reflective surface.

8. The lighting apparatus as claimed in claim 1, wherein the light source is selected from a group consisting of a cold cathode fluorescent lamp (CCFL), a hot cathode fluorescent lamp (HCFL), a light emitting diode (LED), a halogen lamp, a high intensity discharge (HID) lamp and an incandescent Lamp.

9. The lighting apparatus as claimed in claim 1, wherein the guiding micro-structures and the dispersing micro-structures are formed as one piece together with the substrate.

10. The lighting apparatus as claimed in claim 1, wherein the material of the microstructure cover is photo-curing resin, propylene, polymethylmethacrylate (PMMA) or Polycarbonate (PC).

11. The lighting apparatus as claimed in claim 1, wherein the thickness of the substrate is larger than 1 mm.

12. The lighting apparatus as claimed in claim 1, wherein the guiding micro-structures are formed on one side of the substrate, and the dispersing micro-structures are formed on the opposite side thereof.

13. The lighting apparatus as claimed in claim 1, wherein the guiding micro-structures and the dispersing micro-structures are formed on one side of the substrate.

14. The lighting apparatus as claimed in claim 1, wherein the guiding micro-structures are selected from a group consisting of triangular awl structures, triangular pillar structures and Fresnel lens structures.

15. The lighting apparatus as claimed in claim 1, wherein the dispersing micro-structures are selected from a group consisting of semicircle pillar structures, semicircle protruding structures, fish-eye lens structures.

16. The lighting apparatus as claimed in claim 1, wherein the lighting apparatus comprises two light sources respectively disposed at two opposite sides of the chamber of the casing.

17. The lighting apparatus as claimed in claim 1, wherein the profile of the casing is L-shaped.

18. The lighting apparatus as claimed in claim 1, wherein the profile of the casing is U-shaped.

19. The lighting apparatus as claimed in claim 1, wherein the light source include a light emitting surface to emit the light, and the angle between the reflective surface of the casing and the light emitting surface of the light source is less than 90 degrees.

20. A lighting apparatus, comprising:
a casing including a chamber and a reflective surface, wherein the reflective surface is formed in the chamber;
at least light source disposed on at least one side of the chamber; and
a microstructure cover mounted on the chamber of the casing and opposite to the reflective surface, wherein the microstructure cover comprises:
a substrate, wherein the thickness of the substrate is larger than 1 mm;
a plurality of guiding micro-structures formed on one side of the substrate and faced to the reflective surface of the casing, wherein the guiding micro-structures guides the light emitted from the light source in a direction which is substantially vertical to the substrate; and
a plurality of dispersing micro-structures formed on the opposite side of the substrate, wherein the dispersing micro-structures disperses the light emitted from the light source.
